(19) United States
(12) Patent Application Publication
(10) Pub. No.: US 2007/0106032 A1
(43) Pub. Date: May 10, 2007

(54) Crosslinked rubber product

(75) Inventor: Chikara Yamada, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 11/589,220

(22) Filed: Oct. 30, 2006

(30) Foreign Application Priority Data
Nov. 8, 2005 (JP) 2005-323441

(51) Int. Cl. C08F 136/00

(52) U.S. Cl. 525/331.9

(57) ABSTRACT

A crosslinked rubber product which is molded into a desired shape with crosslinking from a rubber compound composed of liquid rubber and compounding ingredients, wherein the crosslinked rubber product is characterized by having a value of permanent compression set (S) of 0.2 to 25% (measured according to JIS K6262) and a value of Asker C hardness (H) of 10 to 83 (measured according to JIS K6253), with S and H satisfying the next following (1).
S≦28.8−0.34H (1) The crosslinked rubber product has high performance (small permanent compression set as well as low hardness) which has never been achieved by ones in the past.

### CROSS-REFERENCE TO RELATED APPLICATION

This non-provisional application claims priority under 35 U.S.C. §119(a) on Patent Application No. 2005-323441 filed in Japan on Nov. 8, 2005, the entire contents of which are hereby incorporated by reference.

### BACKGROUND OF THE INVENTION

1. Field of the Invention

The present invention relates to a crosslinked rubber product which exhibits low hardness and yet small permanent compression set because it is made of liquid rubber.

2. Description of the Related Art

Crosslinked rubber products are usually produced by compounding, molding, and crosslinking (or curing). Compounding is a process of mixing raw rubber with reinforcing agent, fillers, softeners, anti-aging agent, etc., thereby preparing a rubber compound. The rubber compound is made crosslinkable by incorporation with a crosslinking agent and accelerator. Crosslinking is accomplished simultaneously with or after molding.

Reinforcing agent and fillers involved in compounding are usually powder, and hence they easily scatter when they are mixed with raw rubber. Mixing in a short time without compounding ingredients scattering needs an internal mixer such as Banbury and Kneader mixer. See for example, Japanese Patent Laid-open No. 2000-129037 (hereinafter referred to as Patent Document 1) and Japanese Patent Laid-open No. 2005-154545 (hereinafter referred to as Patent Document 2).

On the other hand, it is also common practice to incorporate raw rubber with a large amount of liquid rubber in order to improve processability or to reduce the hardness of rubber products. This holds true for rollers and blades fitted in an electrophotographic printer which needs low hardness (See Patent Document 2).

The simple mixing of solid rubber with liquid rubber usually does not give a rubber compound that meets the requirement for small permanent compression set as well as low hardness. Moreover, when an internal mixer is used to mix together solid rubber, liquid rubber, and compounding ingredients, liquid rubber sticks to the rotor of the mixer, thereby preventing the uniform dispersion of compounding ingredients.

### SUMMARY OF THE INVENTION

The present invention was completed in view of the foregoing. It is an object of the present invention to provide a high-performance crosslinked rubber product with small permanent compression set as well as low hardness.

In order to achieve the above-mentioned object, the present inventor carried out a series of researches which led to the finding of a new crosslinked rubber product molded from a rubber compound composed of liquid rubber and compounding ingredients. The crosslinked rubber product according to an embodiment of the present invention is characterized by small permanent compression set as well as low hardness. That is, it has a value of permanent compression set (S) of 0.2 to 25% (measured according to JIS K6262) and a value of Asker C hardness (H) of 10 to 83 (measured according to JIS K6253), with S and H satisfying the relation (1) below.
S≦28.8−0.34H (1)
The crosslinked rubber product is obtained from a rubber compound composed of liquid rubber, such as low-molecular-weight butadiene rubber and isoprene rubber, and compounding ingredients including a crosslinking agent. The rubber compound is prepared by mixing the liquid rubber with compounding ingredients in a planetary mixer (having a container that rotates and revolves simultaneously for both mixing and defoaming). Mixing in a planetary mixer permits compounding ingredients to thoroughly disperse into liquid rubber, without liquid rubber sticking to the mixer, while allowing complete defoaming. The resulting rubber compound is molded into a desired shape and crosslinked. The crosslinked rubber product thus obtained has the above-mentioned performance which has never been achieved by ones in the past.

The gist of an embodiment of the present invention resides in a crosslinked rubber product which is molded into a desired shape with crosslinking from a rubber compound composed of liquid rubber and compounding ingredients, wherein the crosslinked rubber product is characterized by having a value of permanent compression set (S) of 0.2 to 25% (measured according to JIS K6262) and a value of Asker C hardness (H) of 10 to 83 (measured according to JIS K6253), with S and H satisfying the relation (1) above.

The crosslinked rubber product according to an embodiment of the present invention has high performance (small permanent compression set as well as low hardness) which has never been achieved by ones in the past.

### BRIEF DESCRIPTION OF THE DRAWING

FIG. 1 is a graph showing the relationship between permanent compression set and Asker C hardness.

### DETAILED DESCRIPTION OF THE PREFERRED EMBODIMENTS

A detailed description of the invention will be given below.

The crosslinked rubber product according to an embodiment of the present invention is obtained from a rubber compound composed of liquid rubber and compounding ingredients by molding and subsequent crosslinking.

The liquid rubber as the major constituent of the crosslinked rubber product according to an embodiment of the present invention is not specifically restricted so long as it is liquid at normal temperature and it becomes elastic upon crosslinking. It should be properly selected according to uses to which the crosslinked rubber product is applied. It includes, for example, butadiene rubber, isoprene rubber, chloroprene rubber, butadiene rubber with acrylic-modified terminals, hydroxyl-terminated butadiene rubber, hydroxyl-terminated isoprene rubber, acrylonitrile butadiene rubber, ethylene-propylene-diene rubber, and epichlorohydrin rubber, which are all in liquid form. Preferable among them are butadiene rubber, isoprene rubber, butadiene rubber with acrylic-modified terminals, hydroxyl-terminated butadiene rubber, and hydroxyl-terminated isoprene rubber. Of these examples, the one which has a number-average molecular weight of 2000 to 50000 is most suitable.

More than two kinds of liquid rubber may be used together. Moreover, the liquid rubber may be mixed with solid rubber in a ratio of from 100:5 to 100:20 by weight. However, according to an embodiment of the present invention, it is desirable to use liquid rubber alone without solid rubber at all. Sheer liquid rubber used as the raw rubber certainly yields the crosslinked rubber product having small permanent compression set as well as low hardness. Incidentally, solid rubber for incorporation into solid rubber includes natural rubber, isoprene rubber, butadiene rubber, styrene-butadiene rubber, ethylene-propylene rubber, chloroprene rubber, nitrile rubber, and epichlorohydrin rubber.

The liquid rubber may be incorporated with any compounding ingredients suitable for the crosslinked rubber product. One of the compounding ingredients is a crosslinking agent for hot curing. The crosslinking agent may be selected from any known ones, such as organic peroxide, sulfur, organosulfur compound, and metal oxide, according to the type of the liquid rubber and the use of the crosslinked rubber product. Organic peroxides are particularly desirable. Their typical examples include 1,1-di(t-hexylperoxy)-3,3,5-trimethylcyclohexane, 1,1-di(t-amylperoxy)-3,3,5-trimethylcyclohexane, 1,1-di(t-butylperoxy)cyclohexane, 1,1-di(t-hexylperoxy)cyclohexane, 2,2-di(t-butylperoxy)cyclohexane, n-butyl-4,4-di(t-butylperoxy)valerate, and di(2-t-butylperoxyisopropyl)benzene.

Crosslinking may be accomplished in any way, which is not restricted to hot curing with the above-mentioned crosslinking agent. One way of crosslinking is by irradiation of the liquid rubber (containing a photopolymerization initiator) with ultraviolet rays. The photopolymerization initiator is not specifically restricted. It may be selected from any known ones as exemplified below. 4-dimethylaminobenzoic acid, 4-dimethylaminobenzoic ester, 2,2-dimethoxy-2-phenylacetophenone, acetophenonediethylketal, alkoxyacetophenone, benzyldimethylketal, benzophenone, benzophenone derivatives (such as 3,3-dimethyl-4-methoxybenzophenone and 4,4-diaminobenzophenone), alkyl benzoylbenzoate, bis(4-dialkylaminophenyl)ketone, benzyl, benzyl derivatives (such as benzylmethyl ketal), benzoin, benzoin derivatives (such as benzoin isobutyl ether and benzoin isopropyl ether), 2-hydroxy-2-methylpropiophenone, 1-hydroxycyclohexylphenylketone, xanthone, thioxanthone, thioxanthone derivatives, fluorene, 2,4,6-trimethylbenozyldiphenylphosphineoxide, bis(2,6-dimethoxybenzoyl)-2,4,4-trimethylpentylphosphineoxide, bis(2,4,6-trimethylbenzoyl)-phenylphosphineoxide, 2-methyl-1-[4-(methylthio)phenyl]-2-morpholinopropane-1, and 2-benzyl-2-dimethylamino-1-(morpholinophenyl)-butanone-1. They may be used alone or in combination with one another.

The mixing of liquid rubber with the crosslinking agent or photopolymerization initiator mentioned above gives a curable rubber compound. The curable rubber compound may be incorporated with any known compounding ingredients (such as filler, electrically conducting filler, vulcanization accelerator, reinforcing agent, softener, and anti-aging agent), according to need.

Examples of the filler include carbon black, calcium carbonate, silica, clay, magnesium carbonate, and magnesium silicate.

Examples of the electrically conductive filler include gas black (such as Ketjen black and acetylene black), oil furnace black (including ink black), and carbon black (such as thermal black, channel black, and lamp black). They also include ionically conductive fillers exemplified by tetraethylammonium, tetrabutylammonium, dodecyltrimethylammonium (such as lauryltrimethylammonium), octadecyltrimethylammonium (such as stearyltrimethylammonium), hexadecyltrimethylammonium, benzyltrimethylammonium, modified aliphatic dimethylethylammonium; ammonium salts of perchloric acid, chloric acid, hydrochloric acid, bromic acid, iodic acid, hydroborofluoric acid, sulfuric acid, alkylsulfuric acid, carboxylic acid, and sulfonic acid; and alkali metal (lithium, sodium, etc.) salts and alkaline earth metal (calcium, magnesium, etc.) salts of perchloric acid, chloric acid, hydrochloric acid, bromic acid, iodic acid, hydroborofluoric acid, trifluoromethylsulfuric acid, and sulfonic acid.

The vulcanization accelerator is exemplified by ethylenedimethacrylate, trimethylolpropane trimethacrylate, triallylisocyanurate, and triallylcyanurate. The softener is exemplified by paraffinic oil, naphthenic oil, aromatic oil, adipic ester, and sebacic ester. The anti-aging agent is exemplified by those which are derived from phenol, imidazole, and amine.

The crosslinked rubber product according to an embodiment of the present invention is composed of the above-mentioned liquid rubber, and hence it has small permanent compression set (0.2 to 25% measured according to JIS K6262) as well as low hardness (10 to 83 in terms of Asker C hardness, measured according to JIS K6253).

Moreover, the crosslinked rubber product according to an embodiment of the present invention has the permanent compression set (S) and the Asker hardness (H) such that they satisfy the relation (1) below. (In other words, it meets the requirement for both small permanent compression set and low hardness.)
S≦28.8−0.34H (1)

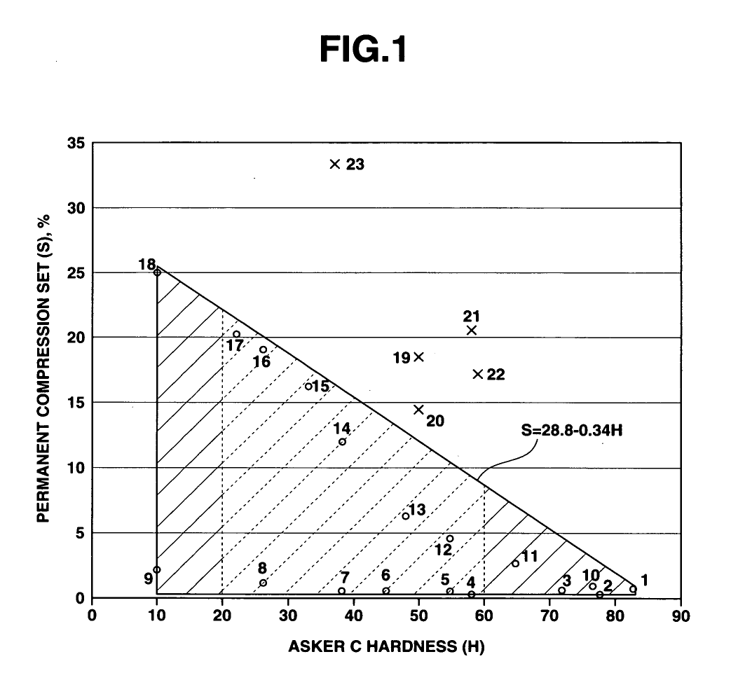

The relation between the permanent compression set (0.2 to 25%) and the Asker hardness (10 to 83) is graphically shown in FIG. 1 (hatched part).

The hatched part (with broken lines) in FIG. 1 indicates the desirable value of Asker C hardness (20 to 60) and the desirable value of permanent compression set that satisfies the relation (1). The desirable values vary depending on the use of the crosslinked rubber product.

Production of the crosslinked rubber product according to an embodiment of the present invention involves two steps; preparation of a curable rubber compound from the liquid rubber and compounding ingredients by mixing and subsequent defoaming and crosslinking (or curing) of the rubber compound. The first step should preferably be accomplished by using a planetary mixer in place of Banbury or Kneader mixer. A planetary mixer of common type is acceptable which has rotating and revolving paddles, mixing arms, and mixing blades. However, it is desirable to employ one which has a container that rotates and revolves simultaneously for both mixing and defoaming. This planetary mixing-defoaming apparatus permits the uniform and efficient dispersion of compounding ingredients into the liquid rubber while preventing the liquid rubber from sticking to the apparatus. Moreover, it permits the efficient production of a high-quality curable rubber compound on account of simultaneous mixing and defoaming. It is commercially available under the trade name of AR-100, ARV-200, AR-250, AR-500, ARV-1000, and ARV-300 (from Thinky Corporation) and Mazerustar KK-50S, KK-100, KK-300, and KK-10000 (from Kurabo Industries Ltd.).

Mixing conditions (speed, temperature, duration, etc.) may be properly established without specific restrictions according to the kind and amount of the liquid rubber and compounding ingredients.

The curable rubber compound prepared in the mixing step mentioned above is subsequently molded into a desired shape and finally cured to give the crosslinked rubber product as desired. Molding may be accomplished in any manner, preferably by using a liquid injection molding machine, in which crosslinking takes place simultaneously with injection molding.

The crosslinked rubber product according to an embodiment of the present invention is characterized by small permanent compression set as well as low hardness, as mentioned above. It will find various uses without specific restrictions after molding into a desired shape and optional secondary fabrication such as polishing and cutting. It contains uniformly dispersed fillers and electrically conductive fillers and it has small permanent compression set as well as low hardness. It exhibits its characteristic properties and outstanding performance when it is used in the field of electrophotographic systems and electrostatic recording systems (such as printers and copying machines). Its typical applications include rollers (such as toner transporting rollers, development rollers, charging rollers, transferring rollers, and paper feed rollers) and blades (such as development blade to form a toner layer and cleaning blade). These rollers and blades are required to have low hardness, good durability, and uniform electrical conductivity. Such requirements are met by the crosslinked rubber product according to an embodiment of the present invention.

### EXAMPLES

The invention will be described in more detail with reference to the following Examples and Comparative Examples, which are not intended to restrict the scope thereof.

### Examples 1 to 18

Samples of curable liquid rubber compounds were prepared according to the formulations (in parts by weight) shown in Tables 1 to 4 by mixing (with simultaneous defoaming) under the following conditions in a planetary mixing-defoaming machine (Model AR-25, from Thinky Corporation).

Mixing conditions in Examples 1 to 18
Machine: rotary mixing-defoaming apparatus
Speed of rotation: 400 rpm
Speed of revolution: 800 rpm
Duration of mixing: 5 minutes

Each of the curable rubber compounds was made into the crosslinked rubber product by injection molding and subsequent crosslinking for 120 to 600 seconds. Injection molding was accomplished by using a liquid injection molding machine (LIM) equipped with a mold previously heated at 170° C. The mold has four cavities for specimens (29 mm in diameter and 12.7 mm thick) to be tested for permanent compression set.

### Comparative Examples 1 to 5

Rubber compounds according to the formulations shown in Tables 4 and 5 were prepared in the following manner. First, mastication was performed on the raw rubber at 85° C. in a Kneader (with a capacity of 500 cc). The raw rubber was mixed for 5 minutes with compounding ingredients except for crosslinking agent (Perhexa TMH or Perhexa C-40). The mixed rubber was discharged and made into a sheet, which was subsequently allowed to cool to room temperature. The cooled sheet was mixed again at 50° C. with a crosslinking agent (Perhexa TMH or Perhexa C-40) with a capacity of 500 cc in the same Kneader as mentioned above. Thus there was obtained a rubber compound. This rubber compound was filled into a mold which has four cavities for specimens to be tested for permanent compression set. Molding was followed by crosslinking at 170° C. for 20 minutes. Thus there was obtained the sample of crosslinked rubber product.

The specimen of the crosslinked rubber products was tested for permanent compression set according to JIS K6262 and Asker C hardness according to JIS K6253 that provides the method for testing vulcanized rubber. The results are shown in Tables 1 to 5 and FIG. 1.

TABLE 1

| | Example | | | | | |
|---|---|---|---|---|---|---|
| | 1 | 2 | 3 | 4 | 5 | 6 |
| LIR-30 | | | | | | |
| LIR-300 | | | | | | |
| BAC-45 | 100 | 100 | 100 | 100 | 100 | 100 |
| Perhexa TMH | 1.5 | 0.6 | 0.3 | 0.15 | 0.125 | 0.1 |
| Mixer | Planetary | Planetary | Planetary | Planetary | Planetary | Planetary |
| Asker C hardness | 83 | 78 | 72 | 58 | 55 | 45 |
| Permanent compression | 0.5 | 0.3 | 0.5 | 0.2 | 0.4 | 0.4 |
| set JIS K6262 (%) | | | | | | |
| Plot No. in FIG. 1 | 1 | 2 | 3 | 4 | 5 | 6 |

LIR-30: Liquid isoprene rubber, from Kuraray Co., Ltd.
LIR-300: Liquid butadiene rubber, from Kuraray Co., Ltd.
BAC-45: Liquid polybutadiene with acrylic terminals, from Osaka Organic Chemical Industry Ltd.
Perhexa TMH: 1,1-di(t-hexylperoxy)-3,3,5-trimethylcyclohexane, from NOF Corporation

TABLE 2

| | Example | | |
|---|---|---|---|
| | 7 | 8 | 9 |
| LIR-30 | | | 50 |
| LIR-300 | | | 50 |
| BAC-45 | 100 | 100 | |
| Perhexa TMH | 0.075 | 0.05 | 1 |
| Mixer | Planetary | Planetary | Planetary |
| Asker C hardness | 38 | 26 | 10 |
| Permanent | 0.4 | 1 | 2 |
| compression set JIS | | | |
| K6262 (%) | | | |
| Plot No. in FIG. 1 | 7 | 8 | 9 |

LIR-30: Liquid isoprene rubber, from Kuraray Co., Ltd.
LIR-300: Liquid butadiene rubber, from Kuraray Co., Ltd.
BAC-45: Liquid polybutadiene with acrylic-modified terminals, from Osaka Organic Chemical Industry Ltd.
Perhexa TMH: 1,1-di(t-hexylperoxy)-3,3,5-trimethylcyclohexane, from NOF Corporation

TABLE 3

| | Example | | | | | |
|---|---|---|---|---|---|---|
| | 10 | 11 | 12 | 13 | 14 | 15 |
| LIR | | | 100 | | 100 | |
| LIR-30 | | 100 | | 40 | | |
| LIR-300 | | | | 60 | | |
| LIR-390 | 100 | | | | | |
| iP | | | | | | 100 |
| Perhexa TMH | 3 | | | 2 | | |
| Perhexa V-40 | | | | | | 25 |
| Perbutyl P-40 | | 8 | 8 | | 6 | |
| Ketjen black EC | | 3 | 3 | 3 | 3 | |
| Mixer | Planetary | Planetary | Planetary | Planetary | Planetary | Planetary |
| Asker C hardness | 77 | 65 | 55 | 48 | 38 | 33 |
| Permanent compression | 0.8 | 2.5 | 4.5 | 6.2 | 11.9 | 16.1 |
| set JIS K6262 (%) | | | | | | |
| Plot No. in FIG. 1 | 10 | 11 | 12 | 13 | 14 | 15 |

LIR: Liquid isoprene rubber, from Kuraray Co., Ltd.
LIR-30: Liquid isoprene rubber, from Kuraray Co., Ltd.
LIR-300: Liquid butadiene rubber, from Kuraray Co., Ltd.
LIR-390: Liquid butadiene/isoprene copolymer, from Kuraray Co., Ltd.
iP: Hydroxyl-terminated liquid isoprene, from Idemitsu Kosan Co., Ltd.
Perhexa TMH: 1,1-di(t-hexylperoxy)-3,3,5-trimethylcyclohexane, from NOF Corporation
Perhexa V-40: n-butyl-4,4-di(t-butylperoxy)valerate, 40% diluted, from NOF Corporation Perbutyl
P-40: di(2-t-butylperoxyisopropyl)benzene, 40% diluted, from NOF Corporation
Ketjen black EC: from Ketjen Black International company Ltd.

TABLE 4

| | | | | Comparative | |
|---|---|---|---|---|---|
| | Example | | | Example | |
| | 16 | 17 | 18 | 1 | 2 |
| Natural rubber | | | | 100 | |
| BR730 | | | | | 100 |
| LIR-300 | | | 100 | | |
| R-45HT | 100 | | | | |
| B-1000 | | 100 | | | |
| Zinc oxide | | | | 5 | 5 |
| Stearic acid | | | | 1 | 1 |
| Perhexa TMH | 6 | 10 | 0.6 | 1.2 | 0.6 |
| Ketjen black EC | | | 3 | | |
| Mixer | Planetary | Planetary | Planetary | 500 cc | 500 cc |
| | | | | Kneader | Kneader |
| Asker C hardness | 26 | 22 | 10 | 50 | 50 |
| Permanent | 19 | 20.1 | 25 | 18.2 | 14.1 |
| compression | | | | | |
| set JIS K6262 | | | | | |
| (%) | | | | | |
| Plot No. in FIG. 1 | 16 | 17 | 18 | 19 | 20 |

BR730: Polybutadiene rubber, from JSR Corporation
LIR-300: Liquid butadiene rubber, from Kuraray Co., Ltd.
R-45HT: Hydroxyl-terminated liquid polybutadiene, from Idemitsu Kosan Co., Ltd.
B-1000: Liquid polybutadiene, from Nippon Soda Co., Ltd.
Perhexa TMH: 1,1-di(t-hexylperoxy)-3,3,5-trimethylcyclohexane, from NOF Corporation
Ketjen black EC: from Ketjen Black International company Ltd.

TABLE 5

| | Comparative Example | | |
|---|---|---|---|
| | 3 | 4 | 5 |
| BR-01 | 100 | | |
| IR-2200 | | 100 | 100 |
| LIR-30 | 20 | 20 | 60 |
| #5500 | 24 | 24 | 24 |
| Zinc oxide | 5 | 5 | 5 |
| Stearic acid | 1 | 1 | 1 |
| Perhexa C-40 | 1.5 | 4 | 4 |
| Mixer | 500 cc | 500 cc | 500 cc |
| | Kneader | Kneader | Kneader |
| Asker C hardness | 58 | 59 | 37 |
| Permanent compression set | 21.9 | 17.2 | 33.3 |
| JIS K6262 (%) | | | |
| Plot No. in FIG. 1 | 21 | 22 | 23 |

BR-01: Polybutadiene rubber, from JSR Corporation
IR-2200: Isoprene rubber, from JSR Corporation
LIR-30: Liquid isoprene rubber, from Kuraray Co., Ltd.
#5500: Electrically conductive carbon black, from Tokai Carbon co., Ltd.
Perhexa C-40: 1,1-di(t-butylperoxy)cyclohexane, 40% diluted, from NOF Corporation

It is noted from Tables 1 to 5 that the crosslinked rubber product according to an embodiment of the present invention has small permanent compression set as well as low hardness. It is also noted that the mixing method used to prepare the crosslinked rubber product is effective in reducing permanent compression set as well as hardness to a great extent.

Japanese Patent Application No. 2005-323441 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A crosslinked rubber product which is molded into a desired shape with crosslinking from a rubber compound composed of liquid rubber and compounding ingredients, wherein said crosslinked rubber product is characterized by having a value of permanent compression set (S) of 0.2 to 25% (measured according to JIS K6262) and a value of Asker C hardness (H) of 10 to 83 (measured according to JIS K6253), with S and H satisfying the relation (1) below.
S≦28.8−0.34H (1)

2. The crosslinked rubber product as defined in claim 1, wherein the rubber component is liquid rubber.

3. The crosslinked rubber product as defined in claim 1, wherein the liquid rubber is one or more than one species selected from liquid butadiene rubber, liquid isoprene rubber, liquid butadiene/isoprene copolymer rubber, liquid butadiene rubber with acrylic-modified terminals, hydroxyl-terminated liquid butadiene rubber, and hydroxyl-terminated liquid isoprene rubber.

4. The crosslinked rubber product as defined in claim 1, wherein the liquid rubber is one which has a number-average molecular weight of 2000 to 50000.

5. The crosslinked rubber product as defined in claim 1, wherein one of the compounding ingredients is carbon black.

6. The crosslinked rubber product as defined in claim 1, which is heat-cured by a peroxide as the crosslinking agent.

7. The crosslinked rubber product as defined in claim 6, wherein the crosslinking agent is one or more than one species selected from 1,1-di(t-hexylperoxy)-3,3,5-trimethyl-cyclohexane, 1,1-di(t-amylperoxy)-3,3,5-trimethylcyclohexane, n-butyl-4,4-di(t-peroxy)valerate, and di(2-t-butylperoxyiso-propyl)benzene.

8. The crosslinked rubber product as defined in claim 1, which is prepared by mixing liquid rubber with compounding ingredients by using a planetary mixer and then curing (by crosslinking) the resulting liquid rubber compound.

9. The crosslinked rubber product as defined in claim 8, wherein the planetary mixer is designed such that the container rotates and revolves simultaneously for mixing and defoaming.

10. The crosslinked rubber product as defined in claim 2, wherein the liquid rubber is one or more than one species selected from liquid butadiene rubber, liquid isoprene rubber, liquid butadiene/isoprene copolymer rubber, liquid butadiene rubber with acrylic-modified terminals, hydroxyl-terminated liquid butadiene rubber, and hydroxyl-terminated liquid isoprene rubber.
